(19) United States
(12) Patent Application Publication
(10) Pub. No.: US 2009/0118452 A1
(43) Pub. Date: May 7, 2009

(54) Method to Decompose the Natural Structure of Biomass

(76) Inventor: Jukka Veli Seppala, Helsinki (FI)

Correspondence Address: KUBOVCIK & KUBOVCIK, SUITE 1105, 1215 SOUTH CLARK STREET, ARLINGTON, VA, 22202, US

(21) Appl. No.: 11/990,212

(22) PCT Filed: Aug. 7, 2006
(86) PCT No.: PCT/FI2006/000271

§ 371 Date: Feb. 8, 2008

(30) Foreign Application Priority Data
Aug. 10, 2005 (FI) 20050811

(51) Int. Cl. C08H 5/02; C07G 1/00; C08H 5/04

(52) U.S. Cl. 527/400; 530/500

(57) ABSTRACT

The invention refers to a method where lactic acid, its water solution, lactide, lactic acid oligomer, polylactic acid or mixture thereof is used for the degradation of cellulose based biomass, such as natural structure of wood, and transformation into plasticized or partly liquefied state so that the cellulose fibers and other components of the biomass can be separated, recovered, modified chemically or recycled by further treatments.

Cellulose is the most common natural polymer. Cellulose fibers in wood bind together by lignin, so it is a question of natural composite material.

Considering the industrial use of wood, particularly the paper making, but also the separation of other valuable components in wood, it is quite essential to separate the cellulose fibers of wood from lignin in an efficient, economical and environmentally friendly way.

Several alternative methods are known for the degradation of natural structure of wood, and particularly the separation of lignin and cellulose fibers from each other, from which some are in a wide industrial use and they are well-known. Wood and other cellulose based materials can be processed further by several different technologies, which are mechanical, chemical, thermochemical or thermal conversion methods. Cellulose can be separated from wood by different techniques chemically, mechanically or by combination of these. The most important application of cellulose is paper making, but also cellulose derivatives can be manufactured such as viscose and rayon.

In a sulphate process, so-called white alkali consists of sodium hydroxide and sodium sulphide, which are present in the boiling of wood chips. Thus, so-called black liquor is formed when lignin degrades and dissolves, and cellulose fibers separate to their own fibrous phase. In this method the cooking is performed at high pressure and temperature and it requires long cooking time. Black liquor is concentrated in a multi-stage evaporator and burned for the production of energy. Sodium carbonate and sodium sulphide and small amount of sodium sulphate are formed. Moreover in the process, sodium carbonate is converted to sodium hydroxide at which the original white alkali can be regenerated. The sulphate process is the leading technology for the production of cellulose.

In a sulphite process, active sulphur containing compounds are sulphur dioxide, hydrogen sulphite ions and sulphite ions. According to the acidity of the cooking can be separated acidic sulphite process, bisulphite process, neutral sulphite process and alkaline sulphite process. Disadvantage of the sulphite process is the sulphur containing compounds used in it, which are problematic from an environmental point of view.

In the thermal grinding process the fiber mass is produced from wood by mechanical shearing and elevated temperature. The required energy consumption of the process is high, but lignin in wood stays in the product mass.

Organic solvents are used in the so-called organosolv processes. These processes are presented among others in the reference publication: Gullichsen ja Fogelholm, Chemical pulping, TAPPI 1999.

So-called Alcell process uses mixture of ethanol and water in the cooking of cellulose at approximate temperature of 190-200° C.

In the Organocell process, the cooking is performed in a mixture of methanol and alkali at temperature of 160-180° C.

Formic acid together with peroxy formic acid has successfully been used in so-called Milox process.

Lignin is high molecular weight, crosslinked polymer, which contains abundantly phenolic units. Thus, the separation of lignin from wood mass is not solely physical solubilization process, but it is a question of partial degradation of crosslinked lignin molecule into smaller dissolving fragments.

According to the present invention, also partial degradation of lignin can occasionally bring advantage.

Disadvantage of the present level of technology is considered to be fairly harsh conditions, consequently depending on the applied technology, high temperature, high pressure, long cooking times and consequently high energy consumption. Also, environmental aspects, such as the use of sulphur containing compounds, are still important aspects to be developed considering the present level of technology.

### DESCRIPTION OF THE INVENTION

Now it has surprisingly been observed that the natural structure of biomaterial, especially wood can be partially or completely degraded, so to get cellulose based biomaterial such as wood entirely or partly into plastisized form, or considering the main components lignin and cellulose to be separated from each other so that lignin dissolves partly or entirely and cellulose fibers remain in a fibrous form dispersed into a solution, when cellulose based biomaterial such as wood chips or other suitable form of wood is heat treated, for example boiled or refluxed in a solution, in which the main or only component is lactic acid, aqueous solution of lactic acid, or oligomerizing or polymerizing lactic acid.

The invention is particularly surprising due to a fact that the conditions for the cooking of cellulose can be fairly mild performed in a vessel with mixing, temperature of 80-180° C., advantageously 130-160° C. is observed to be sufficient without overpressure and without any added components. For the acceleration of the process, overpressure can be used and even higher temperatures. Moreover, it has surprisingly been observed that fairly short treatment times are needed for separation of fibers and lignin, typically good results have already been received by applying cooking times of 1-3 hours.

Thus, a great potential is foreseen for to apply the method according to the invention. The method enables to obtain recovery method, particularly cellulose technique for biomass such as wood and wood components, based on closed circulations, energy saving and utilizing biomass based raw materials.

Energy saving is achieved by the fact that the cooking can beneficially be performed at an atmospheric pressure or only by using of slight overpressure. Also, the fact that required temperature level is relatively low, yields a great energy saving.

Significant advantage in the use of lactic acid for the separation of components and ingredients of wood and conversion of them into liquefied form is that no sulphur containing compounds are present.

Except for the needs of the manufacture of cellulose the method according to the invention can also be applied for the separation and recovery of valuable ingredients of wood. One can mention among others betulin, hemicelluloses, lignin, lignans just to mention a few.

The environmental aspect is significant in the method according to the invention. Lactic acid can namely be produced from some biomass based sugar crude material source by fermentation. Thus, it deals with a technology and method utilizing annually renewable raw materials. Lactic acid exists in two stereoforns L- and D-forms, in addition their mixture or racemic lactic acid exists. In the view of the invention all the mentioned forms of lactic acid can be used. It is also noteworthy, that lactic acid occurs generally as an aqueous solution, but conversely with the removal of water it starts to polymerize first to oligomers and then to higher molecular weight polymers. Polymerization is a natural and easily occurring phenomenon but it can be accelerated with suitable catalysts like with tin octoate. Under suitable conditions, lactic acid also forms a dimer or lactide which also in principle can be applied as component according to the invention.

The method according to the invention also enables production of cellulose based on closed circulations, thus lactic acid can be separated after the cooking and recycled in the process.

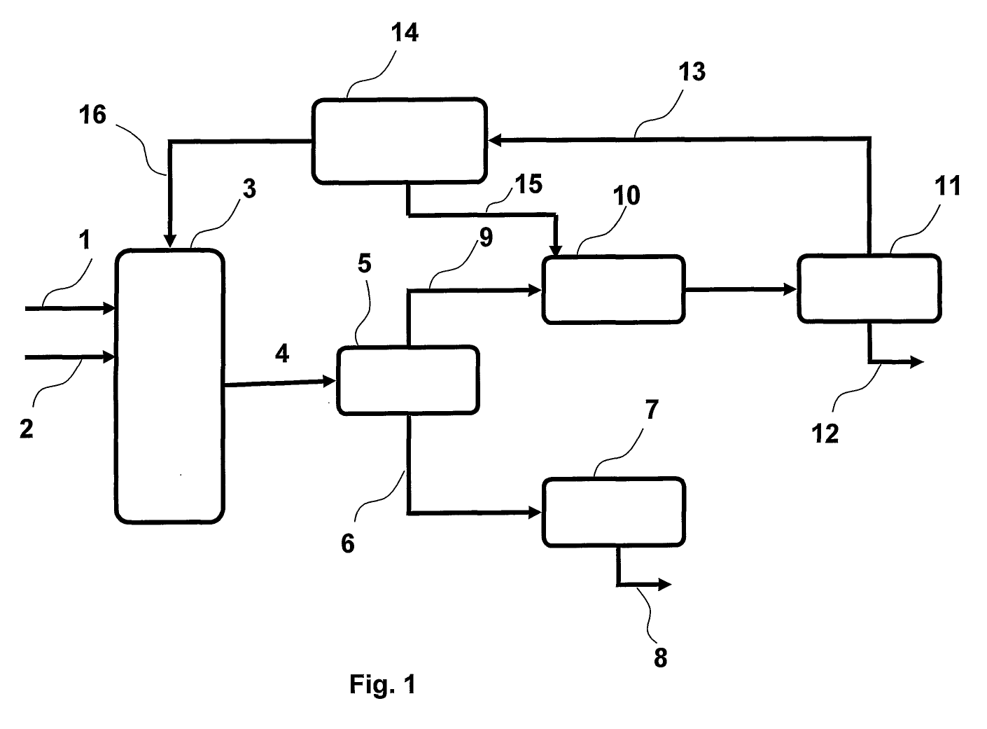

Certain advantageous performance manner and process according to the invention is presented as block diagram in FIG. 1, which represents one possible application form according to the invention, however not excluding other industrial applications and possibilities.

In FIG. 1 lactic acid, aquoeus solution of lactic acid or lactic acid oligomer (1) is fed to the stirred reaction vessel (3), the temperature of which is close to the boiling point of the mixture, typically 130-140° C. Biomass is also fed to the reaction vessel, advantageously wood chips (2) so that the mass ratio of lactic acid solution and wood chips is approximately 1 mass part of biomass and 4 mass parts of lactic acid component. The temperature of the mixed vessel is increased to 140° C. and the stirring is continued for 4-5 hours. Formed black mass, where lignin is dissolved apart from other biomass is pumped along the line (4) to the filtration equipment (5). In the filtration stage the fibrous cellulose mass is separated. It can be washed with lactic acid solution and water. Cellulose mass is transferred along the line (6) to drying stage (7), from which dry fiber mass is obtained as final product (8).

The filtrate obtained from the filtration equipment contains besides the lactic acid components also the dissolved lignin component. The filtrate is pumped along the line (9) into a precipitation tank (10), where dissolved lignin is precipitated by water to form a solid powder.

By filtration (11) the lignin can be separated and recovered (12) and the lactic acid containing aqueous solution can be recycled along the line (13) to concentration (14) where the produced water is passed on along the line (15) for precipitation (10) of lignin and concentrated lactic acid is further recycled along the line (16) in the reaction vessel (3).

Certain advantageous form of application of the invention is such where water is let to leave from the mixture during the cooking when lactic acid oligomerizes and polymerizes at the same time when the natural structure of wood degrades. Subsequently the end result is a mixture of lignin, cellulose fibers and polylactic acid.

Except that a mixture of components is applied, furthermore such a structure where lactic acid has also reacted and polymerized in lignin or alternatively reacted with the chemical —OH groups of cellulose and thereafter polymerizing can be advantageously applied.

Subsequently achieved composition of polylactic acid and wood ingredients can be farther functionalized and for example crosslinked with the assist of crosslinkable reactive components to obtain beneficial plastic-like, technical properties.

Furthermore we have also surprisingly observed that a method according to the present invention can be applied to dissolve solid powder form lignin that is formed large quantities as a side stream in forest industry, into lactic acid within a wide concentration range. Even over 80 wt-% of lignin is dissolved into 88% aqueous solution of lactic acid. Furthermore lactic acid and lignin together can be condensed at heat and with possibly added catalyst, such as tin octoate, to produce a polymeric structure.

### EXAMPLES

### Example 1

### Cooking of Hardwood Material

Cooking of aqueous lactic acid and hardwood chips. The cooking was performed in a 100 ml round bottomed flask which was equipped with refluxing condenser and magnetic stirrer. The heating and magnetic stirring was performed with Heidolph heat plate (MR 3001 K) and temperature probe (EKT 3001) attach to it. 40 g of lactic acid (88% water solution, 97.5 wt-%) and 1 g (2.5 wt-%) of wood chips were added into the round bottomed flask. The vessel was innmersed in an oil bath with a temperature of 100° C. and the stirring was started at the speed of 200 rpm. Temperature was increased quickly to 115° C., where it was kept during 4 hours with refluxing mixture. The oil bath temperature was increased to 145° C., where it was kept for another 4 hours. Correspondingly, the inside temperature of the flask was 125° C. As end-product was obtained a dark solution, where lignin had essentially dissolved, and where the wood material had plasticized.

### Example 2

### Cooking of Hardwood Material

Cooking of aqueous lactic acid and hardwood chips with larger ratio of components. Cooking was performed as in Example 1, however with the following amounts of the ingredients and keeping the oil bath temperature at 145° C. during the entire cooking time. 50 g of lactic acid (88% water solution, 85 wt-%) and 10 g of wood chips (15 wt-%) were added into the round bottomed flask and the mixture was refluxed for 5 hours. As an end-product was obtained dark slurry, where the lignin from wood material was in a liquefied state and the cellulose fibers were clearly detected separately.

### Example 3

### Cooking of Hardwood Material

Cooking of aqueous lactic acid and hardwood chips with overhead stirrer mixing (Heidolph RZR2102 Control). Cooking was performed in a 250 ml reaction vessel, which was equipped with refluxing condenser and overhead stirrer. 150 g of lactic acid (88% water solution, 85 wt-%) and 30 g of wood chips (15 wt-%) were added to the vessel. The vessel was immersed in the bath and the mixing started at a rate of 70 rpm when the moment of the stirrer was 23,5 Ncm. Temperature was quickly increased to 145° C. when the mixing moment was 18.6 Ncm. After one hour the mixing speed was increased to 140 rpm where the mixture was boiled for 10 hours. As an end-product was obtained dark slurry where the lignin was dissolved as its own liquid phase and the cellulose fibers dispersed apart in the solution as their own phase.

### Example 4

Cooking of dilute lactic acid solution and birch chips. Cooking was performed as in Example 3, but with following amounts of ingredients and the oil bath temperature was 130° C. during the entire cooking. Correspondingly, the inside temperature of the flask was 103° C. Additional water was added into the water solution of lactic acid so that the ratio of lactic acid/water was 50:50. 30 g of birch chips was added into the lactic acid/water-mixture. After boiling for 10 hours, light brown slurry mixture was obtained where softened fiber mass was.

### Example 5

Cooking of dilute lactic acid solution and birch chips. Cooking was performed as in Example 3, but with following amounts of ingredients and the oil bath temperature was 125° C. during the entire cooking. Correspondingly, the inside temperature of the flask was 102° C. Into the water solution of lactic acid was added water so that the ratio of lactic acid/water was 30:70. Into the lactic acid/water-mixture (150 g) was added 30 g of birch chips. The mixture was refluxed for 10 hours after which the fibers had softened and free lignin had dissolved in the liquid phase however clearly less then in the cooking according to example 4. Fibers were separated easily from the liquid phase by suction filtration.

### Esimerkki 6

Cooking according to Example 5 was repeated but the lactic acid/water-mixture with a ratio of 20:80 was used as cooking liquor. A mixture, where the softened fibers were, was obtained after refluxing. Only small amount of lignin had dissolved in the liquid phase. Weight of the dried fiber mass had diminished approximately 20 wt-%.

### Example 7

### Filtration

The hot dark brown mixture according to Example 3 was filtered on a filter paper by suction filtration by using a water pump and a Büchner funnel and finally, the wood mass on the filtrate paper was washed with hot lactic acid-water mixture. Filtrate was dark brown in colour while the separated soft cellulose mass was light brown in colour. After the cooking dried cellulose mass contained fine fiber which was left 15 g (50 wt-%).

### Example 8

Filtration according to Example 7 was repeated but at the end the fiber mass was washed with acetone several times when the free lignin dissolved better into filtrate and more pure fiber mass was obtained as an end-product.

### Example 9

### Compression Moulding of the Fibers

Compression moulding of the fiber mass into a plate. Fiber mass according to example 3 was grinded in a mortar with pestle and finally the mass was compression moulded in a table press (hydraulic hand pump Enerpac P142 and temperature regulator West 6100) at 120° C. into a plate with thickness of 5 mm using processing temperature of 120° C. Paper-like cellulose material was obtained as an end-product.

### Example 10

10 g of pine chips and 40 g of 88% water solution of lactic acid were added into a beaker. Temperature was increased to 140-160° C. and the mixture was mixed with magnetic stirrer. These conditions were kept during 3 hours.

Separation of lignin was observed already after cooking for 15 minutes. At the end of the cooking dark viscous mass was observed to form where the wood particles had dissolved during the solubilization of lignin and separation of fibers from the wood material.

### Example 11

Experiment according to Example 10 was repeated, however with a difference that now the temperature was 130-140° C. during the whole time and the cooking time was 4 hours. During the cooking removed water was replaced so that the mass density remained constant and the viscosity low.

Wood material was observed to soften, lignin to dissolve into liquid phase and cellulose fibers to be separated from the wood material. Finally, the wood particles disappeared entirely when lignin dissolved and cellulose fibers separated from each other.

### Example 12

Experiment according to Example 10 was repeated, however with a difference that the cooking was stopped at that point when part of the wood material was still left but lignin was partly dissolved. Mass was left to cool down and it was grinded with a laboratory grinder when degradation natural structure of wood and separation of cellulose fibers would be clearly detected by optical microscope (Olympus AHBS).

### Example 13

Stems of bamboo plant were mechanically crushed into chips. Cooking was performed in a 100 ml round bottomed flask equipped with refluxing condenser and magnetic stirrer. 8 g (15 wt-%) of bamboo chips and 40 ml of (88% water solution, 85 wt-%) solution of lactic acid and water were placed into the round bottomed flask. The vessel was immersed in the oil bath and the magnetic stirring was started at a speed of 200 rpm. Temperature was increased to 145° C. and the mixture was refluxed for 10 hours, after which the natural structure of bamboo and separation of cellulose to own dispersed phase was observed, so-called could be filtered, washed and dried. In the end 85 wt-% of the washed and dried fiber mass was left from the initial weight or 15 wt-% of lignin had release during the cooking.

### Example 14

Experiment according to Example 13 was repeated, but so that the used biomass was straw particles. 40 g of oat straw and 800 g of lactic acid (88% water solution) were added into the round bottomed flask. The flask was immersed the oil bath with temperature of 100° C. The oil bath temperature was increased to 130° C. and the mixture was refluxed for 5 hours at inside temperature of 124° C. Degradation of natural structure of wood and separation of cellulose fibers were recorded. The fibrous component could be separated and recovered. The pulp was washed with lactic acid and water. The fibers were observed to be separated from each other with microscopic examination (Olympus AHBS). Kappa number of the washed pulp was 43.6.

### Example 15

### Cooking in the Lactic Acid Oligomer

5 g of wood chips and 50 ml of 88% water solution of lactic acid wherein 0.01% of tin octoate was as a catalyst were added into a 100 ml beaker. The mixture was heated steadily starting from temperature of 130° C. Water was removed from the mixture.

Solubilization of lignin from wood material was observed immediately. After three hours dark viscous mass was obtained, where the lignin had dissolved and lactic acid had oligomerized and polymerized.

### Example 16

Cooking according to Example 15 was repeated but with different amounts of ingredients and in different conditions. 170 g of lactic acid (88% water solution, 95 wt-%) and 8 g of hardwood chips and 0.01 g of tin octoate were added into a 250 ml reaction vessel. The reaction vessel was equipped with overhead stirrer, condenser with round bottomed flask and inlet tube for nitrogen. The vessel was immersed in the oil bath and the mixing was started at a speed of 120 rpm and dry nitrogen was led into with the tube. Temperature was increased to 140° C. during an hour and to 180° C. with a rate of 10° C./h and kept at that temperature for another 7 hours. Formed water was collected to distil flask during the whole reaction. Dark, hard and brittle oligomerized resin, which is viscous liquid at elevated temperature, was obtained as an end-product.

### Example 17

Solubilization of Lignin into Lactic Acid

15 g of aqueous lactic acid (88% water solution) was added into aluminum dish, and then lignin as a powder form was added gradually starting with a temperature of 100° C. Immediately lactic acid dyed into dark colour. Temperature was increased and more lignin added, consequently temperature was 180° C. at the end and the added amount of lignin was approximately 80 wt-%. Stiff mass, which was paste-like at elevated temperature, was obtained as end-product. Microscopic observation showed that lignin had dissolved into lactic acid.

### Example 18

Oligomerization of Lactic Acid with Lignin

Experiment according to Example 16 was repeated, but with following ingredients and amounts of ingredients: 68,2 g of lactic acid (88% water solution) and 0.01 wt-% of tin octoate was added to a 100 ml round bottomed flask and 40 g of lignin was gradually added to the vessel under stirring. The ratio of lactic acid and lignin was 60:40. Total reaction time was 6 hours. Hard, brittle oligomerized resin, which can be functionalized and crosslinked with peroxides, was obtained as end-product.

### Example 19

### End-Functionalization of Lactic Acid Oligomer

Product (55 g, 90 wt-%) obtained according to Example 18 was immersed in an oil bath at a temperature of 100° C. and the mass was heated to 130° C. Stirring and nitrogen flow was started and 6.1 g (10 wt-%) of methacrylic anhydride was added. Mixture was kept at these conditions for 3 hours. Hard, brittle resin, which can, be crosslinked by peroxides at elevated temperatures into a network-like structure, was obtained as end-product.

### Example 20

### Recovery of Lignin

Cooking liquor obtained after filtration according to Example 7 was diluted with water to precipitate the lignin residue. Addition of water with ratio of 1:3 (cooking liquor:water) precipitated most of the lignin. Lignin was filtered off by suction filtration and dried at elevated temperature to constant weight. Lignin was very fine brown powder and slow to filter. The dilute filtrate was clear and orange in colour.

### Example 21

Experiment according to Example 20 was performed. However, precipitated lignin was treated at elevated temperature before filtration. Lignin was treated at 70-80° C. for 20 minutes. As a result, lignin coagulated and it was easy to recover by filtration.

### Example 22

### Reuse of Cooking Liquor

Cooking reactions were performed according to Example 1, but in different conditions. Three batches of birch were cooked in the same lactic acid liquor without precipitation of lignin in between. Each cooking boiled for 6 hours in a ratio 1:4 (wood: 88% lactic acid) at 124-126° C. Delignification of wood was observed to occur in each case. However, the delignification appeared to diminish slightly in the second and the third cooking which was seen by the increasing amount of sticks (undissolved wood) in the cellulose material. The viscosity of cooking liquor was higher in the second and third cooking as a result of increasing lignin content. Obtained pulps were washed by hot lactic acid solution and water several times. Kappa numbers of pulp from first and second cooking were 46.9 and 51.5, respectively.

### Example 23

### Additional Washing of Pulp

Washed pulp obtained from Example 14 was further washed with 2% NaOH solution at temperature of 60° C. for 10 minutes. Finally, the pulp was washed with water. Washing with dilute NaOH solution proved to be excellent since the kappa number of pulp reduced to 17.3.

### Example 24

### Cooking of Flax Plant (Chemical Retting)

Cooking according to Example 1 was performed, however with following amounts of ingredients and conditions. 35 g of cut flax plant and 525 g of lactic acid (5% water solution) were added to the round bottomed flask corresponding to the straw:liquor ratio of 1:15. The flask was immersed to the oil bath with temperature of 115° C. where it was kept for 5 hours. Correspondingly, the inside temperature of reactor was approximately 100° C. After retting at elevated temperature, the bark of the flax softened and lignin and pectin components dissolved or dispersed into the liquor. Flax fibers were easily separated from the stem by mechanical treatment. Flax fibers were light in colour.

### Example 25

Cooking according to Example 1 was performed, however with following amounts of ingredients and conditions. 20 g of cut flax plant and 400 g of lactic acid (0.1% water solution) were added to the round bottomed flask corresponding to the straw:liquor ratio of 1:20. The flask was immersed to the oil bath with temperature of 115° C. where it was kept for 5 hours. Correspondingly, the inside temperature of reactor was approximately 100° C. After retting at elevated temperature, the bark of the flax softened and lignin and pectin components dissolved or dispersed into the liquor. Flax fibers were separated from the stem by mechanical treatment.

### Example 26

### Cooking of Waste Wood

Cooking according to Example 1 was performed, however with following amounts of ingredients and conditions. 100 g of stump particles and 500 g of lactic acid (88% water solution) were added to the round bottomed flask corresponding to the wood:liquor ratio of 1:5. The flask was immersed to the oil bath with temperature of 140° C. where it was kept for 18 hours. Correspondingly, the inside temperature of reactor was 125° C. Delignification was observed to occur partially. The cooking liquor was dark brown in colour and the stump particles had softened and degraded. However, more severe conditions are needed to achieve required degree of delignification.

### Example 27

Impregnation of Lactic Acid into Wood

30 g of birch chips and 300 g of lactic acid (20% water solution) were pretreated separately in oven with temperature of 100° C. for 10 minutes. Subsequently, the warm birch chips were immersed into the warm lactic acid solution and placed back to the oven. The pressure of the oven was reduced to 250 mbar. The vacuum was gradually released to normal pressure during 15 minutes. As a result, the lactic acid solution penetrated into the birch chips and the chips were slightly softer.

Mechanical shearing force can be applied to the softened chips in the production of chemimechanical mass. Softening of the chips by lactic acid solution is expected to decrease the energy consumption of the process.

### Example 28

### Bleaching of the Fiber Mass

10 g of birch pulp obtained according to Example 3 was immersed into the dilute hydrogen peroxide solution. The mixture was heated up to 60° C. and kept there for 5 hours. Subsequently, the fiber material bloated and lightened in colour (from brown to light yellow). In addition, the fibers were curlier and less stiff than the unbleached fiber mass.

1. Method and process for decomposition of the natural structure of cellulose based biomass in particle form and transformation of it into plasticized or flowing state characterized in that degradation of structure and at least partial solubilization of the binding components are brought about by using lactic acid, aqueous solution of lactic acid, lactide, a dimer or oligomer of lactic acid, or mixture thereof as a solution preferably in water.

2. Method according to claim 1, characterized in that it can be applied to separate lignin or equivalent binding component such as hemicellulose, lignans and betulin from a particle-formed cellulose based biomass, while transferring the biomass by at least partial solubilization of the binding components into plasticized or flowing state.

3. Method according to claim 1, characterized in that it can be applied to recover cellulose fibres from the produced flowing mass.

4. Method according to claim 1, characterized in that it can be performed at temperatures of 60 . . . 250° C., advantageously at temperatures of 110 . . . 160° C. and at a pressure from normal atmospheric pressure up to overpressure of 50 bar.

5. Method according to claim 1, characterized in that the ratio of water and lactic acid or a polymeric component derived from it is within 95 wt-%/5 wt-% . . . 0.1 wt-%/99.9 wt-%.

6. Method according to claim 1, characterized in that dissolved lignin or equivalent binding component can be precipitated for recovery by addition of water.

7. Method according to claim 1, characterized in that in addition to the chemical treatment, mechanical shearing force can be applied to the biomass.

8. Method according to claim 1, characterized in that the lactic acid and/or the component derived from it can be recycled for reuse in the process.

9. Method according to claim 1, characterized in that lactic acid degrades chemically lignin or equivalent binding component of a cellulose based biomass, typically of wood, at least partially.

10. Method according to claim 1, characterized in that lactic acid or its oligomer reacts chemically with the functional groups on lignin or equivalent binding component, or on cellulose, or on both, when ester bonds between reacting molecules are formed.

11. Method according to claim 1, characterized in that lactic acid and/or its oligomer, having reacted with functional groups of molecules in solution or functional groups on cellulose, polymerizes further and so produces crosslinked molecular structures.

12. Method according to claim 1, characterized in that from the recovered cellulose fibres can be produced all typical products of biomass fibres, as of wood fibres, such as cellulose pulp, liquid cellulose, paper, paper-board, cardboard, non-woven textile, however not excluding other applications of biomass fibres.

13. Method according to claim 1, characterized in that the cellulose based biomass to be degraded can consist of different kind of wood in particle form, such as softwood or hardwood, straw, bagasse, flax, reed canary grass, waste wood, bamboo or biomass originating from different cane plants, just to mention a few, however not excluding other analogous cellulose based biomasses as raw materials.

14. (canceled)

15. Method of decomposing a natural structure of cellulose based biomass in particle form, comprising the steps of
degrading and solubilizing binding components from between fibres at least partially, in an optionally aqueous solution containing lactic acid, lactic acid oligomer, polymerized lactic acid, lactide, or mixtures thereof, and
simultaneously liquefying the biomass or transferring it into a plasticized or a flowing state and separating and recovering the binding components of said biomass and recovering fibrous cellulose components.
